(19) United States
(12) Patent Application Publication
(10) Pub. No.: US 2009/0108672 A1
(43) Pub. Date: Apr. 30, 2009

(54) COMBINATION REGENERATIVE AND FRICTION BRAKING SYSTEM FOR AUTOMOTIVE VEHICLE

(76) Inventor: John Patrick Joyce, West Bloomfield, MI (US)

Correspondence Address: Dickinson Wright PLLC, 38525 Woodward Avenue, Suite 2000, Bloomfield Hills, MI, 48304, US

(21) Appl. No.: 11/923,710

(22) Filed: Oct. 25, 2007

(51) Int. Cl. B60T 8/64

(52) U.S. Cl. 303/152

(57) ABSTRACT

A combination regenerative and friction braking system for an automotive vehicle includes an active booster master cylinder and a number of wheel cylinders connected to the master cylinder. A brake control unit is connected with brake pipes extending from the master cylinder to the wheel cylinders. At least one pressure reducing valve is positioned in one of the brake pipes so as to allow the active booster master cylinder to actuate selective ones of the wheel cylinders during regenerative braking without activating wheel cylinders servicing wheels which are being braked regeneratively.

### BACKGROUND OF THE INVENTION

1. Field of the Invention

The present invention relates to a braking system for a vehicle having one or more road wheels with both friction and regenerative braking capability.

2. Disclosure Information

The design and implementation of braking systems for vehicles having regenerative braking capability presents special challenges because road wheels which are braked regeneratively generally require the availability of friction brakes as well. Both regenerative and friction brakes must be used on wheels which are braked regeneratively because regenerative braking is not available from time to time. For example, when an energy storage device incorporated within the regenerative braking system, such as a traction battery or pumped storage accumulator, is fully charged, regenerative capability may not be available. Moreover, regenerative braking capability is usually less than the capability commonly associated with friction braking. Thus, regenerative braked wheels must have friction brakes as well to assure that the vehicle has adequate brake power capability under foreseeable operating conditions.

Another issue with respect to regenerative braking rises from the need to achieve brake application transparency. Because wheels being braked regeneratively require less braking power from the hydraulic master cylinders commonly associated with friction braking systems, it is necessary to provide high pressure brake fluid by means of an active booster master cylinder. This is motivated by the desire to achieve, with respect to the driver, a transparency in brake operation. In other words, equivalent brake pedal travel and effort are sought, regardless of whether regenerative braking is being applied. This transparency assures that the vehicle's operator will be presented with a consistent brake pedal response characteristic.

As noted above, active booster master cylinders are known to be used in regenerative braking systems of hybrid vehicles. In order to properly achieve the transparency described above, the hydraulic pressure which would normally be transmitted to the friction brakes could be limited by the use of solenoid valves employed in a hydraulic or electronic antilock braking or stability control, or traction control unit (HECU). However, such units utilize valves which are typically required to operate at high frequency for very short periods of time, thereby rendering them generally unsatisfactory for use with the type of combined regenerative and friction braking system described in this specification.

It would be desirable to provide a combination regenerative and friction braking system including not only a conventional HECU, but also one or more pressure limiting valves permitting coordinated use of friction and regenerative braking on common road wheels, without the expense and complexity associated with modified HECU hardware.

### SUMMARY OF THE INVENTION

According to an aspect of the present invention, a combination regenerative and friction braking system for an automotive vehicle includes an active booster master cylinder connected with a number of wheel cylinders by means of brake pipes extending from the master cylinder to the wheel cylinders. A brake control unit is connected to the brake pipes. At least one pressure reducing valve is positioned in one of the brake pipes extending from the master cylinder to at least one wheel cylinder servicing a regeneratively breakable wheel.

According to another aspect of the present invention, the pressure reducing valve may be positioned either upstream or downstream from the brake control unit. The brake control unit may itself be configured as an electronic anti-lock braking unit, or a hydraulically actuated anti-lock braking unit, or as an electronic vehicle stability control unit, or an electronic traction control unit.

According to another aspect of the present invention, a braking system may further include a bypass valve mounted in a parallel flow relationship with the pressure reducing valve.

According to another aspect of the present invention, the pressure reducing valve is calibrated to prevent brake fluid from flowing from the master cylinder to a wheel cylinder servicing a regeneratively breakable wheel, at a pressure less than a predetermined pressure corresponding to the braking force produced during maximum regenerative braking. Alternatively, the pressure reducing valve may be calibrated to allow brake fluid to flow from the master cylinder to the wheel cylinder of the regeneratively braked wheel, at a pressure which is proportional to the upstream fluid pressure within the brake pipe to which the pressure reducing valve is attached.

According to another aspect of the present invention, the pressure reducing valve may be configured either as a mechanically actuated valve, or an electronically actuated valve operated by a controller.

According to another aspect of the present invention, an active booster master cylinder according to the present invention may be configured either as a dual master cylinder having a diagonal output, or as a dual master cylinder having front and rear wheel outputs.

According to another aspect of the present invention, the pressure reducing valve may be operated electronically so as to place the valve in a minimal flow restriction configuration if the brake control unit is operating in a stability or traction control mode.

According to another aspect of the present invention, an automotive vehicle includes an internal combustion engine, and a regenerative powertrain driven by the engine, with the regenerative powertrain being operatively connected with a number of road wheels. An energy storage device is coupled to the regenerative powertrain. An active booster master cylinder is connected with a number of wheel cylinders through brake pipes which are also connected with a brake control unit. A pressure reducing valve is operatively associated with one of the brake wheel cylinders servicing a road wheel connected to the regenerative braking device.

According to another aspect of the present invention, the pressure reducing valve operates to prevent the flow of brake fluid to at least one wheel cylinder operatively associated with a regeneratively braked wheel whenever the output pressure of the active booster master cylinder is less than a predetermined output pressure which would be required to produce an amount of braking equivalent to a maximum amount of regenerative braking.

It is an advantage of a system according to the present invention that standard design solenoid valves may be employed in a hydraulic/electronic control unit (HECU), thereby reducing the cost of implementing a regenerative braking system in a hybrid vehicle.

It is another advantage of a system according to the present invention that braking effort produced by an active booster master cylinder may easily be controlled without the need for extensive additional electronics in the vehicle system.

Other advantages, as well as features of the present invention, will become apparent to the reader of this specification.

### BRIEF DESCRIPTION OF THE DRAWINGS

FIG. 1 is a schematic representation of an automotive vehicle having a braking system according to the present invention.

FIG. 2 is a schematic representation of a braking system incorporated in vehicle 10 having a front/rear brake circuit split.

FIG. 3 is similar to FIG. 2 but shows a braking system having a diagonal brake circuit split.

FIG. 4 depicts a braking system having an electronically controlled pressure reducing valve according to another aspect of the present invention.

### DETAILED DESCRIPTION OF THE PREFERRED EMBODIMENTS

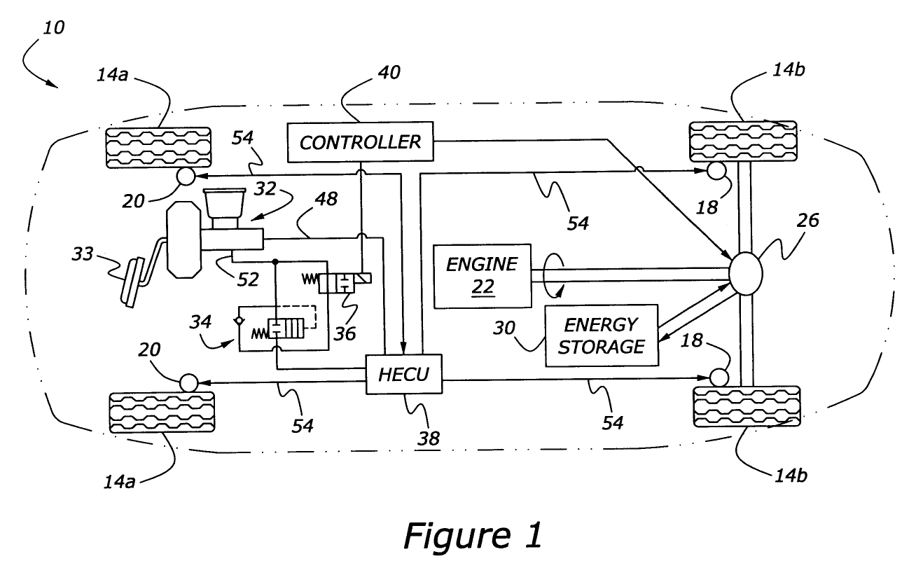

As shown in FIG. 1, vehicle 10 is powered by engine 22, and has a number of road wheels, 14a and 14b. Road wheels 14a are serviced by brake wheel cylinders 20, and road wheels 14b are serviced by brake wheel cylinders 18. Road wheels 14b are both regeneratively breakable. Motor/generator 26, which is incorporated in the regenerative braking system, may comprise either an electrical motor generator, or a fluidic motor/pump, and provides regenerative braking under the command of controller 40. Motor/generator 26 is connected with energy storage device 30, which may be configured as either a traction battery, or a fluid accumulator, or other type of device known to those skilled in the art and both suggested by this disclosure and compatible with the motor/generator 26. Road wheels 14b may be braked regeneratively, so as to recharge energy storage device 30, or road wheels 14b may be braked with friction brakes by means of wheel cylinders 18. Moreover, road wheels 14b may be braked by the simultaneous application of both regenerative and friction braking.

The braking system installed in vehicle 10 includes brake pedal, 33, attached to an active booster master cylinder, 32. Master cylinder 32 provides consistent brake pedal effort and travel regardless of whether vehicle 10 is being braked regeneratively or by friction braking. The brake system further includes a hydraulic or electronic control unit (HECU), 38, which is connected between active booster master cylinder 32 and wheel cylinders 20 and 18. A number of brake pipes, shown at 48, 52, and 54, extend from master cylinder 32 to HECU 38 and ultimately to wheel cylinders 18 and 20. HECU 38 may be configured as an electronic anti-lock braking unit, or a hydraulically actuated anti-lock braking unit, or an electronic vehicle stability control unit, or an electronic traction control unit. Moreover, HECU 38 may be configured as a single unit to perform not only vehicle stability control but also electronic traction control and anti-lock braking as well. This detail is committed to those wishing to employ the system according to the present invention.

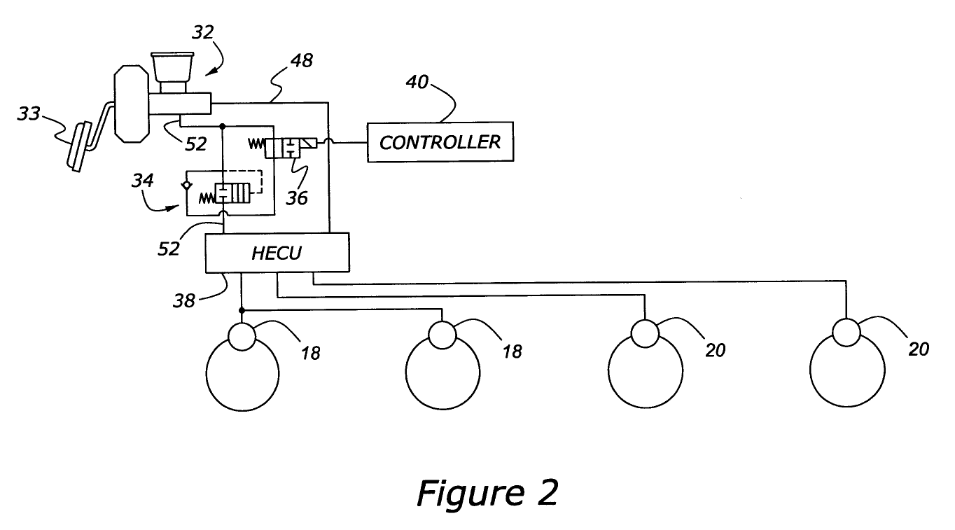

FIG. 2 shows an embodiment according to the present invention in which a single pressure reducing valve, 34, is mounted between master cylinder 32 and HECU 38. Pressure reducing valve 34 is calibrated to prevent brake fluid from flowing from master cylinder 32 to wheel cylinders 18, which service regeneratively breakable wheels 14b, at a fluid pressure less than the predetermined pressure corresponding to the braking force produced during maximum regenerative braking. In other words, pressure reducing valve 34 prevents the flow of brake fluid to wheel cylinders 18 whenever the output pressure of master cylinder 32 is less than the output pressure which would be required to produce an amount of braking equivalent to a maximum amount of regenerative braking. In this manner, wheels 14b may be braked regeneratively, while wheels 14a may be braked with friction brakes at the same time, without the need for triggering any of the electronic valving employed in HECU 38.

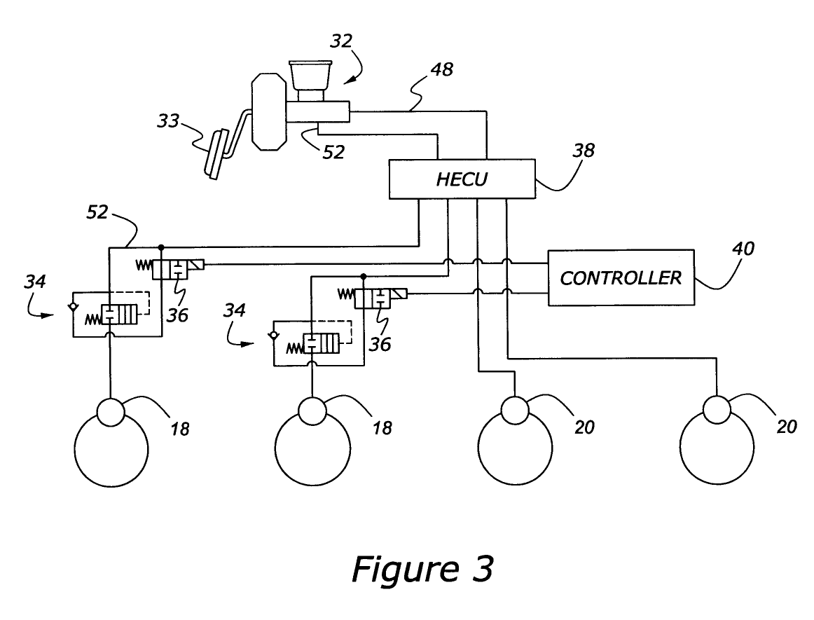

FIG. 2 shows a configuration in which front and rear brakes are split into separate circuits from master cylinder 32. FIG. 3 is similar to FIG. 2, but shows a diagonal brake circuit split. As a result, two pressure reducing valves 34 are employed, one for each of rear wheels 14b. FIGS. 1 and 2 also shows bypass valves 36, which are operated by an electronic controller, 40. Bypass valves 36, as their name implies, allow fluid to pass around pressure limiting valves 34, so as to permit HECU 38 to function independently of pressure reducing valves 34 under certain conditions, such as operation in a traction/stability control mode, so as to allow HECU 38 to draw fluid from the reservoir of master cylinder 32, or to permit sufficient brake force to be developed in the event that the braking system becomes functionally impaired.

According to another aspect of the present invention, pressure reducing valves 34 may be calibrated so as to allow brake fluid to flow from master cylinder 32 to wheel cylinders 18, servicing regeneratively braked wheels 14b, at a pressure which is proportional to the upstream fluid pressure generated by master cylinder 32.

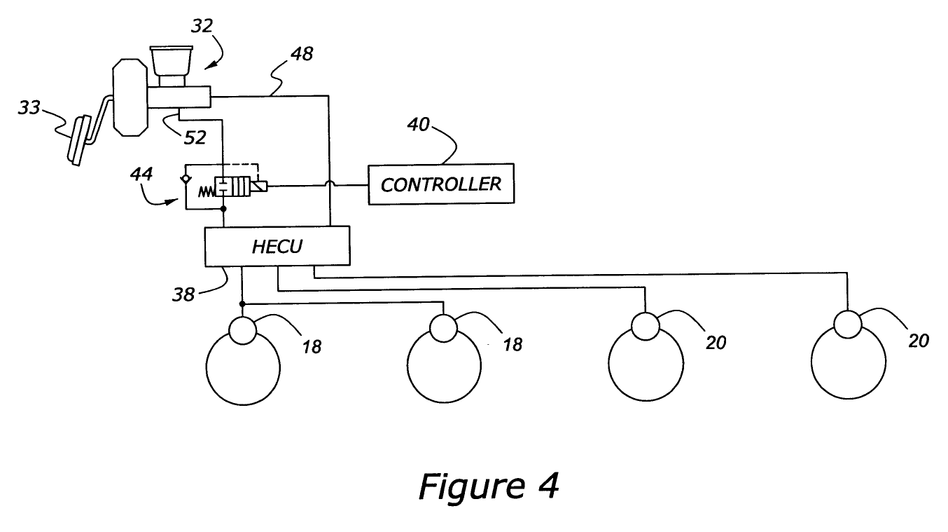

FIG. 4 illustrates an embodiment according to the present invention in which controller 40 operates pressure reducing valve 44, so as to place valve 44 in a minimal flow restriction configuration if HECU 38 is operating in a stability control mode, or in another mode requiring minimal restriction of flow through brake pipe 52 extending between master cylinder 32 and HECU 38. Controller 40 may be either free standing, or integrated with controller 38, or integrated with a powertrain controller or other type of onboard controller.

Although the present invention has been described in connection with particular embodiments thereof, it is to be understood that various modifications, alterations, and adaptations may be made by those skilled in the art without departing from the spirit and scope of the invention set forth in the following claims.

What is claimed is:

1. A combination regenerative and friction braking system for an automotive vehicle, comprising:
an active booster master cylinder;
a plurality of wheel cylinders connected to said master cylinder;
a plurality of brake pipes extending from said master cylinder to said wheel cylinders;
a brake control unit connected with said plurality of brake pipes; and
at least one pressure reducing valve positioned in one of said brake pipes.

2. A braking system according to claim 1, wherein said at least one pressure reducing valve is positioned in a brake pipe extending from said master cylinder to at least one wheel cylinder servicing a regeneratively breakable wheel.

3. A braking system according to claim 2, wherein said at least one pressure reducing valve is positioned at a location upstream from said brake control unit.

4. A braking system according to claim 2, wherein said at least one pressure reducing valve is positioned at a location downstream from said brake control unit.

5. A braking system according to claim 1, wherein said brake control unit comprises an electronic antilock braking unit.

6. A braking system according to claim 1, wherein said brake control unit comprises a hydraulically actuated antilock braking unit.

7. A braking system according to claim 1, wherein said brake control unit comprises an electronic vehicle stability control unit.

8. A braking system according to claim 1, wherein said brake control unit comprises an electronic traction control unit.

9. A braking system according to claim 1, further comprising a bypass valve mounted in a parallel flow relationship with said at least one pressure reducing valve.

10. A braking system according to claim 2, wherein said pressure reducing valve is calibrated to prevent brake fluid from flowing from said master cylinder to said at least one wheel cylinder servicing a regeneratively breakable wheel, at a pressure less than a predetermined pressure corresponding to the braking force produced during maximum regenerative braking.

11. A braking system according to claim 2, wherein said pressure reducing valve is calibrated to allow brake fluid to flow from said master cylinder to said at least one wheel cylinder servicing a regeneratively breakable wheel, at a pressure which is proportional to the upstream fluid pressure within the brake pipe to which the pressure reducing valve is attached.

12. A braking system according to claim 1, wherein said at least one pressure reducing valve comprises a mechanically actuated valve.

13. A braking system according to claim 1, wherein said master cylinder comprises a dual master cylinder having a diagonal output.

14. A braking system according to claim 1, wherein said master cylinder comprises a dual master cylinder having separate front and rear wheel outputs.

15. A regenerative and friction braking system for an automotive vehicle with a plurality of road wheels, with said braking system comprising:
an active booster master cylinder;
a plurality of wheel cylinders connected to said master cylinder;
a brake control unit connected with a plurality of brake pipes extending between said master cylinder and said plurality of wheel cylinders;
a regenerative braking device connected with at least one of the roadwheels; and
at least one pressure reducing valve, positioned in one of said brake pipes extending from said master cylinder to at least one of said wheel cylinders which is operatively associated with a roadwheel connected to said regenerative braking device.

16. A regenerative and friction braking system according to claim 15, further comprising a bypass valve mounted in a parallel flow relationship with said at least one pressure reducing valve.

17. A regenerative and friction braking system according to claim 15, further comprising an electronic controller for operating said pressure reducing valve so as to place the valve in a minimal flow restriction configuration if the brake control unit is operating in a stability control mode.

18. A regenerative and friction braking system according to claim 15, further comprising an electronic controller for operating said pressure reducing valve so as to place the valve in a minimal flow restriction configuration if the brake control unit is operating in a traction control mode.

19. An automotive vehicle, comprising:
an internal combustion engine;
a regenerative powertrain driven by said engine, with said regenerative powertrain being operatively connected with a plurality of roadwheels;
an energy storage device coupled to said regenerative powertrain;
an active booster master cylinder;
a plurality of wheel cylinders connected to said master cylinder;
a brake control unit connected with a plurality of brake pipes extending between said master cylinder and said plurality of wheel cylinders; and
at least one pressure reducing valve, positioned in one of said brake pipes extending from said master cylinder to at least one of said wheel cylinders which is operatively associated with one of said roadwheels connected to said regenerative braking device.

20. An automotive vehicle according to claim 19, wherein said pressure reducing valve operates to prevent the flow of brake fluid to said at least one wheel cylinder operatively associated with a regeneratively braked wheel whenever the output pressure of said master cylinder is less than a predetermined output pressure which would be required to produce an amount of braking equivalent to a maximum amount of regenerative braking.
